(19) United States
(12) Patent Application Publication
(10) Pub. No.: US 2026/0339743 A1
(43) Pub. Date: Oct. 29, 2026

(54) PARALLEL PROCESSING METHOD OF COMPUTATION AND COMMUNICATION, ELECTRONIC DEVICE FOR PERFORMING THE METHOD, AND COMPUTATION-COMMUNICATION SYSTEM

(71) Applicant: SAMSUNG ELECTRONICS CO., LTD., Suwon-si (KR)

(72) Inventor: Jonghoon KANG, Suwon-si (KR)

(73) Assignee: SAMSUNG ELECTRONICS CO., LTD., Suwon-si (KR)

(21) Appl. No.: 19/442,277

(22) Filed: Jan. 7, 2026

(30) Foreign Application Priority Data
Apr. 25, 2025 (KR) 10-2025-0054267
Jun. 19, 2025 (KR) 10-2025-0081368

(51) Int. Cl. G06F 9/50

(52) U.S. Cl. CPC G06F 9/5061

(57) ABSTRACT

An electronic device may include a first memory configured to store data related to a first computation; an accelerator; and a processor configured to determine a chunk unit related to the first computation to be performed by the accelerator; generate a fused kernel that enables an execution of a plurality of partial computations into which the first computation is partitioned based on the chunk unit and a plurality of communications corresponding to the plurality of partial computations in an overlapping manner; and control the accelerator and a computation-memory interface based on the fused kernel.

### CROSS-REFERENCE TO RELATED APPLICATIONS

This application claims priority to Korean Patent Application No. 10-2025-0054267, filed on Apr. 25, 2025, and Korean Patent Application No. 10-2025-0081368, filed on Jun. 19, 2025, in the Korean Intellectual Property Office, the disclosures of which are incorporated herein by reference in their entireties.

### BACKGROUND

### 1. Field

Example embodiments relate to a parallel processing method of computation and communication, an electronic device for performing the method, and a computation-communication system.

### 2. Description of Related Art

To efficiently perform large-scale computations, a structure of connecting multiple computational devices through networks and performing cooperative computations may be used. In this system, the performance of collective communication for data exchanges between multiple computational devices, as well as the computation performance of a single computational device, may serve as a major element affecting the whole computation performance.

### SUMMARY

Aspects of the present disclosure provide a parallel processing method of computation and communication, an electronic device for performing the method, and a computation-communication system. Example embodiments are not limited to the technical tasks described above, and other technical tasks may be inferred from the example embodiments below.

In one or more embodiments, an electronic device may include: a first memory configured to store data related to a first computation; an accelerator; and a processor configured to: determine a chunk unit related to the first computation to be performed by the accelerator; generate a fused kernel that enables an execution of a plurality of partial computations into which the first computation is partitioned based on the chunk unit and a plurality of communications corresponding to the plurality of partial computations in an overlapping manner; and control the accelerator and a computation-memory interface based on the fused kernel; wherein the accelerator is configured to perform a first partial computation among the plurality of partial computations based on the data read from the first memory; and wherein the computation-memory interface is configured to, based on first data indicating a result value of the first partial computation being stored in a second memory, compute second data based on a second computation using the first data and perform a transmission of the second data to one or more first electronic devices.

In one or more embodiments, a parallel processing method performed by an electronic device including a first memory in which data related to a first computation is stored, a processor, an accelerator, a computation-memory interface, and a monitoring-path control device, may include: obtaining communication history information related to a communication performed in the computation-memory interface; determining a chunk unit based on the communication history information, information on a capacity of a second memory included in the computation-memory interface, information on the data, information on an amount of computation of the first computation, information on a processing rate of the accelerator, information on a topology related to the electronic device, and information on a configured algorithm corresponding to the topology; generating a fused kernel that enables an execution of a plurality of partial computations into which the first computation is partitioned based on the chunk unit and a plurality of communications corresponding to the plurality of partial computations in an overlapping manner; and based on the fused kernel, controlling the accelerator to perform the plurality of partial computations and controlling the computation-memory interface to perform the plurality of communications.

In one or more embodiments, a computation-communication system may include: a plurality of switches having a topology; and a plurality of electronic devices connected to the plurality of switches, wherein, based on a receiving device for an electronic device among the plurality of electronic devices, including one or more first electronic devices, and a transmitting device for the electronic device, including one or more second electronic devices, wherein the electronic device may include: a first memory configured to store data related to a first computation; and a processor configured to: determine a chunk unit related to the first computation be performed by an accelerator; generate a fused kernel that enables an execution of a plurality of partial computations into which the first computation is partitioned based on the chunk unit and a plurality of communications corresponding to the plurality of partial computations in an overlapping manner; and control the accelerator and a computation-memory interface based on the fused kernel; wherein the accelerator is configured to perform a first partial computation among the plurality of partial computations based on the data read from the first memory; and wherein the computation-memory interface is configured to, based on first data indicating a result value of the first partial computation being stored in a second memory, compute second data based on a second computation using the first data and data received from each of the one or more second electronic devices, and perform a transmission of the second data to the one or more first electronic devices.

According to example embodiments, it is possible to optimize a chunk unit such that a time period of a partial computation corresponds to a time period of a communication corresponding to the partial computation based on a variety of information. Accordingly, a bottleneck may be minimized in parallel processing of computation and communication, thereby reducing a time to complete the parallel processing of computation and communication.

Effects of example embodiments are not limited to those described above, and other effects not mentioned herein may be clearly understood by those skilled in the art from the appended claims.

### BRIEF DESCRIPTION OF DRAWINGS

These and/or other aspects, features, and advantages of the invention will become apparent and more readily appreciated from the following description of example embodiments, taken in conjunction with the accompanying drawings of which:

FIG. 1 is a block diagram for illustrating an electronic device including a first memory, a controller, an accelerator, and a computation-memory interface according to one or more embodiments;

FIG. 2 is a block diagram for illustrating an electronic device including a first memory, a controller, an accelerator, a computation-memory interface, and a monitoring-path control device according to one or more embodiments;

FIG. 3 is a block diagram for illustrating a computation-memory interface according to one or more embodiments;

FIG. 4 is a block diagram for illustrating a computation-communication system including a plurality of switches and a plurality of electronic devices according to one or more embodiments;

FIG. 5 is a flowchart for illustrating a parallel processing method of computation and communication, performed by an electronic device, according to one or more embodiments;

FIG. 6 is a flowchart for illustrating a method of determining a chunk unit and generating a fused kernel, performed by an electronic device, according to one or more embodiments;

FIG. 7 is a flowchart for illustrating a parallel processing and synchronization method of computation and communication, performed by an electronic device, according to one or more embodiments;

FIG. 8 is a diagram for illustrating a topology structure related to a plurality of electronic devices included in a computation-communication system according to one or more embodiments;

FIG. 9 is a diagram for illustrating a method of processing a plurality of collective communications, performed by an electronic device, according to one or more embodiments;

FIG. 10 is a diagram for illustrating a method of adjusting a time period of a partial computation and a time period of a communication corresponding to the partial computation by adjusting a chunk unit according to one or more embodiments;

FIG. 11 is a diagram for illustrating a graph representing a time period of a partial computation and a time period of a communication corresponding to the partial computation based on a chunk unit being adjusted according to one or more embodiments;

FIG. 12 is a diagram for illustrating a computation-memory interface according to one or more embodiments;

FIG. 13 is a diagram for illustrating a computation-memory interface according to one or more embodiments; and

FIG. 14 is a flowchart for illustrating a parallel processing method of computation and communication, performed by an electronic device, according to one or more embodiments.

### DETAILED DESCRIPTION

Terms used in example embodiments are selected from general terms currently widely used when possible based on the functions in the present disclosure. However, the terms may vary depending on the intention of a person skilled in the art, precedents, the advent of new technology, or the like. Further, in particular cases, there are also terms arbitrarily selected by the applicant, and in these cases, the meaning will be described in detail in the corresponding descriptions. Therefore, the terms used in the present disclosure are not to be construed simply as their designations but based on the meanings of the terms and the overall context of the present disclosure.

Throughout the specification, when a part is described as “comprising or including” a component, it does not exclude another component but may further include another component unless otherwise stated. Further, terms such as “ . . . unit,” “ . . . part,” and “ . . . module” described herein refer to a unit that processes at least one function or operation, which may be implemented as hardware, software, or a combination thereof.

Hereinafter, example embodiments of the present disclosure are described in detail with reference to the accompanying drawings, so that those skilled in the art may easily implement example embodiments. However, the present disclosure may be implemented in many different forms and is not limited to example embodiments described herein.

One or more embodiments of the present disclosure relate to a software-hardware co-optimized collective communication overlap designed to overcome the inefficiencies of conventional software-based collective communication implementations. One or more embodiments provide (1) utilizing different memory bandwidths by storing intermediate computation results in on-chip memory (SRAM) to avoid conflicts between computation and communication streams, and (2) optimizing the computation chunk size to ensure that partial computations and collective communications are maximally overlapped. This approach enables simultaneous computation and communication, improving both speed and efficiency in accelerator-based systems such as graphics processing units (GPUs).

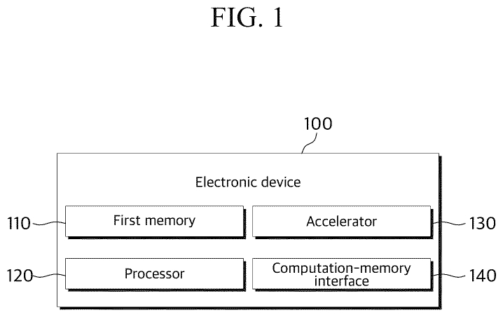

FIG. 1 is a block diagram for illustrating an electronic device including a first memory, a controller, an accelerator, and a computation-memory interface according to one or more embodiments.

Referring to FIG. 1, an electronic device 100 may include a first memory 110, a processor (also referred to as a controller) 120, an accelerator 130, and a computation-memory interface 140. FIG. 1 illustrates elements of the electronic device 100 related to example embodiments. Therefore, it may be understood by those skilled in the art that other general-purpose elements may be further included, in addition to the elements illustrated in FIG. 1.

The electronic device 100 may process a first computation and a collective communication corresponding to the first computation in parallel. Here, the first computation according to one or more embodiments may include at least one of general matrix-matrix multiplication (GEMM) and general matrix-vector multiplication (GEMV), but is not limited thereto. For example, the first computation may include a computation based on a tensor of three or more dimensions, such as tensor times matrix (TTM) and tensor times tensor (TTT).

According to one or more embodiments, if a distributed computation is divided and performed by a plurality of electronic devices included in a computation-communication system, the electronic device 100 included in the plurality of electronic devices may process the first computation, which is a portion of the distributed computation, and the collective communication related to the first computation. For example, if the distributed computation is an operation of computing matrix C by multiplying matrix A and matrix B (C=A×B), the electronic device 100 may compute C′, a submatrix of matrix C, through the first computation, which is a matrix multiplication between matrix A and B′, a submatrix of matrix B. Here, C′, which is a submatrix according to one or more embodiments, may be determined by dividing or partitioning matrix C column-wise based on information (for example, the number of the plurality of electronic devices) on the plurality of electronic devices in the computation-communication system, but is not limited thereto. For example, the submatrix C′ may be determined by dividing matrix C row-wise or batch-wise.

Data used by the electronic device 100 to perform computations may be stored in the first memory 110. Here, the first memory 110 according to one or more embodiments may be a dynamic random access memory (DRAM) and high bandwidth memory (HBM), but is not limited thereto. If the electronic device 100 performs the first computation, data related to the first computation may be stored in the first memory 110. Further, result data from the first computation may be stored in the first memory 110. For example, if the first computation is a matrix multiplication between matrix A and B′, a submatrix of matrix B, data related to matrix A and data related to submatrix B′ may be stored in the first memory 110. Further, data related to submatrix C′ may be stored as a result from the first computation in the first memory 110. To efficiently manage memory space, data used for the first computation alone may be stored in the first memory 110, but example embodiments are not limited thereto, and the entire data used for the distributed computation may be stored.

The processor 120 may control overall operations of the electronic device 100. Here, the processor 120 according to one or more embodiments may be a general-purpose processor such as a central processing unit (CPU), an application processor (AP), and a digital signal processor (DSP), but is not limited thereto. The processor 120 may generate a fused kernel where a plurality of partial computations and a plurality of communications are maximally overlapped based on a chunk unit, and based on the fused kernel, control the accelerator 130 to perform the plurality of partial computations and control the computation-memory interface 140 to perform the plurality of communications. Since the processor 120 controls the accelerator 130 and the computation-memory interface 140 based on a single fused kernel, a memory bandwidth may be greatly reduced and synchronization between threads may be minimized, compared to a case where a computation kernel and a communication kernel are configured as individual kernels. Accordingly, the efficiency of a parallel processing method of computation and communication, performed by the electronic device 100, may be greatly increased.

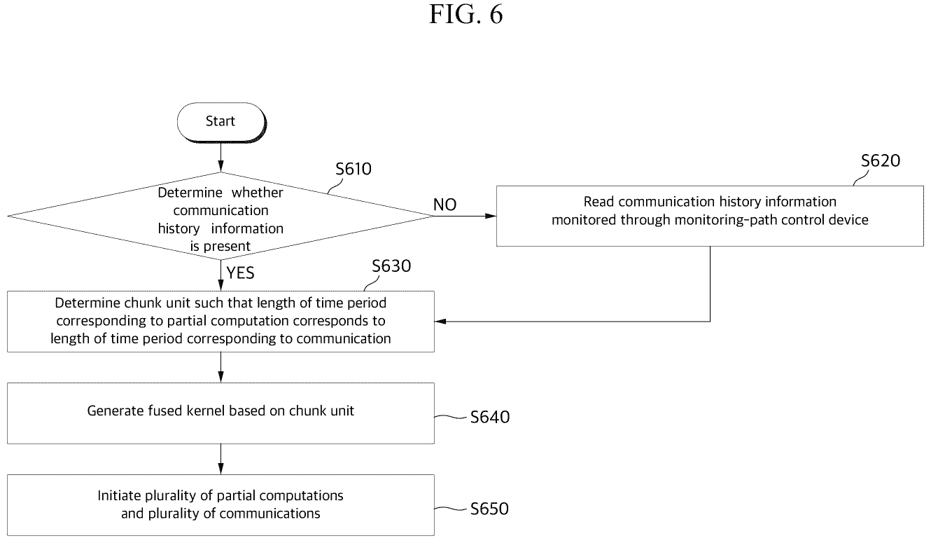

According to one or more embodiments, the processor 120 may determine a chunk unit (e.g., a computation segment) related to the first computation that is to be performed by the accelerator 130. Here, the chunk unit may refer to a unit of data partitioning used to divide the data for the first computation, defined by a predetermined size and may serve as a basic unit for processing an individual partial computation or an individual communication. In this regard, as the number of chunks increases, the chunk unit may be configured to be smaller. The first computation may include a plurality of partial computations partitioned based on the chunk unit, and a communication related to the first computation may include a plurality of communications corresponding to the plurality of partial computations. The processor 120 may determine an optimal chunk unit based on communication history information, information on a capacity of a second memory 142 included in the computation-memory interface 140, information on the data, information on an amount of computation of the first computation, information on a processing rate of the accelerator 130, information on a topology related to the computation-communication system, and information on a configured algorithm corresponding to the topology. The processor 120 may optimize the chunk unit such that a time period of a partial computation performed after a particular partial computation and a time period of a communication corresponding to the particular partial computation, which is performed subsequent to the particular partial computation, are maximally overlapped. A method of determining an optimal chunk unit and generating a fused kernel based on the chunk unit is described in more detail with reference to FIG. 6.

The processor 120 according to one or more embodiments may generate a fused kernel that enables the overlapping execution of the plurality of partial computations (into which the first computation is partitioned by the chunk unit) and their corresponding communications. Here, the fused kernel may integrate a computation kernel (which includes information on the plurality of partial computations and their execution order) and a communication kernel into a single kernel. The information on the plurality of partial computations included in the fused kernel may include information on a computation order between the plurality of partial computations. Further, if the distributed computation involves computing matrix C by multiplying matrix A and matrix B, and the first computation involves computing submatrix C′ by multiplying matrix A and B′, a submatrix of matrix B, one of the plurality of partial computations included in the first computation may be an operation of computing C″, a submatrix of matrix C′, by multiplying matrix A and B″, a submatrix of matrix B′. The submatrix C″ according to one or more embodiments may be determined by dividing matrix C′ in a manner identified based on the number of chunks. Here, the manner may correspond to one of column-wise, row-wise, and batch-wise manners, but is not limited thereto.

The accelerator 130 may be a device for sequentially performing the plurality of partial computations into which the first computation is partitioned. Here, the accelerator 130 according to one or more embodiments may be a graphics-dedicated processor such as a graphics processing unit (GPU) and a vision processing unit (VPU) or an artificial intelligence (AI)-dedicated processor such as a neural processing unit (NPU) and a tensor processing unit (TPU), but is not limited thereto.

The accelerator 130 according to one or more embodiments may read the data related to the first computation from the first memory 110 based on the fused kernel. Subsequently, the accelerator 130 may sequentially perform the plurality of partial computations based on the information on the computation order. However, the accelerator 130 is not limited thereto, and before performing a partial computation among the plurality of partial computations, may read data used to perform the partial computation alone from the data related to the first computation stored in the first memory 110. In other words, the accelerator 130 may read the data related to the first computation all together or read data used to perform a partial computation alone before performing each of the plurality of partial computations.

The accelerator 130 according to one or more embodiments may perform a second partial computation subsequent to a first partial computation. In this case, the accelerator 130 may perform the first partial computation with priority among the plurality of partial computations based on data read from the first memory 110. In response to the first partial computation being completed and first data indicating a result value of the first partial computation being stored in the second memory 142 of the computation-memory interface 140, the accelerator 130 may perform the second partial computation. As used herein, the first data may refer to data indicating a result value of a partial computation.

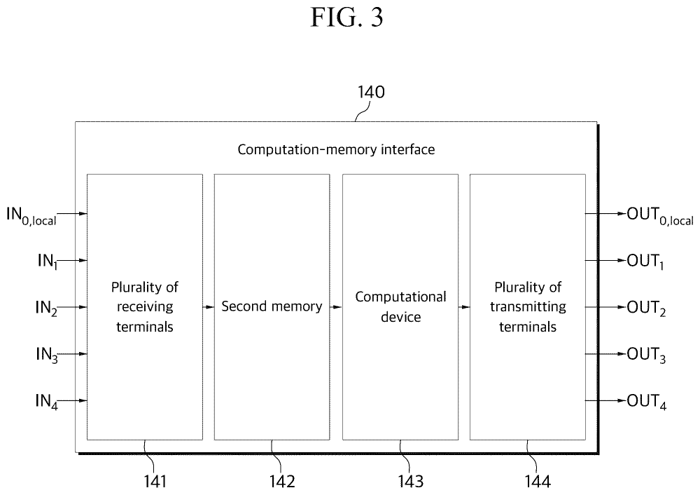

The computation-memory interface 140 may be a stream-based interface for computing second data based on a second computation using the first data indicating a result value of a partial computation and performing a collective communication using the second data. Here, the computation-memory interface 140 may be referred to as a stream compute interconnect (SCI) or a data transfer interface. The computation-memory interface 140 may include memory buffers (e.g., the second memory 142 shown in FIG. 3) that store intermediate computation results (such as partial computations), data transfer units that facilitate the streaming of data between memory and computational units, communication channels that enable efficient collective communication, and control logic (e.g., a computational device 143 which may include a control logic circuit) to manage data flow and ensure that computation and communication processes are properly synchronized, preventing data conflicts or bottlenecks. The computation-memory interface 140 may enable streaming data from local memory such as SRAM or DRAM (e.g., the first memory 110) to a processing unit (e.g., the processor 120 or the accelerator 130), while also handling communication tasks such as broadcasting or reducing data across multiple processing nodes in a distributed system. By supporting parallelism between computation and communication, the computation-memory interface 140 helps improve the overall efficiency and scalability of the system.

The first data according to one or more embodiments may be stored in the second memory 142 (see FIG. 3) of the computation-memory interface 140. However, the first data indicating a result value of a partial computation is not limited thereto and may be stored in a second memory of another electronic device that performs a distributed computation. As an example, if two or more electronic devices are disposed at one node included in a topology, the first data indicating a result value of a partial computation performed in a particular electronic device corresponding to a particular node may be stored in a second memory of a computation-memory interface of another electronic device corresponding to the particular node. As another example, the first data indicating a result value of a partial computation performed in a particular electronic device corresponding to a particular node may be stored in a second memory of a computation-memory interface of another electronic device corresponding to another node adjacent to the particular node. The following description is based on the first data being stored in the second memory included in the computation-memory interface 140.

A computational device (e.g., the computational device 143 in FIG. 3) included in the computation-memory interface 140 may read the first data from the second memory and then compute the second data based on the second computation using the first data. As used herein, the second data may be data targeted for a collective communication. Further, the second computation may refer to a collective computation performed in order for the plurality of electronic devices within the computation-communication system to share or integrate data with each other. The second computation according to one or more embodiments may include at least one of broadcast, reduce, all-reduce, all-gather, reduce-scatter, and all-to-all operations, but is not limited thereto.

According to one or more embodiments, one or more first electronic devices may be a receiving device for the electronic device 100, which is identified based on a topology, and one or more second electronic devices may be a transmitting device for the electronic device 100, which is identified based on a topology. In other words, the one or more second electronic devices may transmit data to the electronic device 100, and the one or more first electronic devices may receive the second data from the electronic device 100. In this regard, the computational device may compute the second data by performing the second computation using the first data and data received from each of the one or more second electronic devices. Subsequently, the computation-memory interface 140 may transmit the second data to the one or more first electronic devices.

Based on how to divide the distributed computation, for example, column-wise, row-wise, or batch-wise, the computational device may perform the second computation for accumulate or integrate the first data and the data received from each of the one or more second electronic devices. As an example, if each row of matrix C in the distributed computation is processed only in one partial computation of one electronic device, the second computation may include integrating the first data and the data received from each of the one or more second electronic devices. As another example, if each row of matrix C in the distributed computation is processed in partial computations of two or more electronic devices, the second computation may include accumulating the first data and the data received from each of the one or more second electronic devices.

According to one or more embodiments, the first data indicating a result value of each of the plurality of partial computations included in the first computation may be accumulatively stored in the second memory. More specifically, the first data may be stored in a first-in first-out (FIFO) or address queue-based manner. The first data indicating a result value of one partial computation may be P×Q, the number of chunks may be N, and the first computation may be divided row-wise. In this case, the first data accumulatively stored in the second memory at a time point when the plurality of communications are completed may be P×NQ. Subsequently, the first data accumulatively stored in the second memory may be stored as the result data from the first computation in the first memory 110.

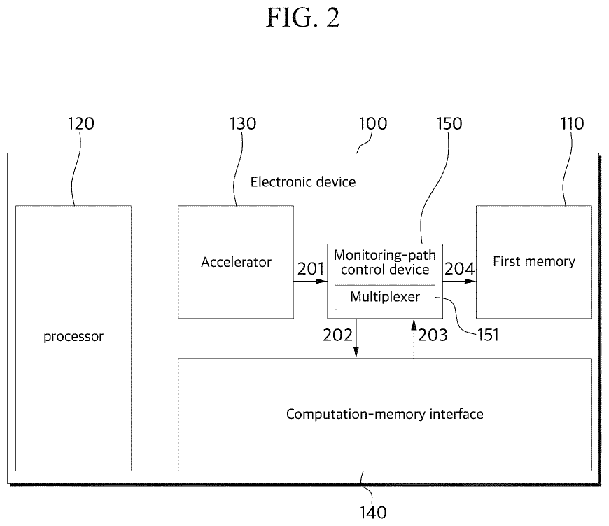

FIG. 2 is a block diagram for illustrating an electronic device including a first memory, a controller, an accelerator, a computation-memory interface, and a monitoring-path control device according to one or more embodiments.

The electronic device 100 according to one or more embodiments is not limited to the electronic device 100 of FIG. 1. For example, the electronic device 100 may further include a monitoring-path control device 150, in addition to the first memory 110, the processor 120, the accelerator 130, and the computation-memory interface 140. Here, the monitoring-path control device 150 may be a device for controlling a path of data written to or read from a memory (for example, the first memory 110 or the second memory). The monitoring-path control device 150 may include a multiplexer 151 and may be connected to a direct memory access (DMA) controller. In this regard, the monitoring-path control device 150 may enable efficient and direct data transfers between the first memory 110, the second memory, and computation units via the DMA controller without involving the processor 120 for every operation. The multiplexer (MUX) is used to select between different data paths based on the control signals, facilitating the routing of data to the appropriate memory location (either the first memory 110 or the second memory).

According to one or more embodiments, a first signal 201 may be a write signal for the first data indicating a result value of a partial computation performed in the accelerator 130. In this case, the monitoring-path control device 150 may hook the first signal 201 and then control a path such that the first data is stored in the second memory within the computation-memory interface 140, bypassing the first memory 110. A second signal 202 may be a signal whose path is controlled such that the first data (resulting from the partial computation performed in the accelerator 130) is stored in the second memory directly, preventing the need for additional intermediaries (e.g., the processor 120). Further, a third signal 203 may be a write signal for the first data accumulatively stored in the second memory at a time point when the plurality of communications are all performed. In this case, the monitoring-path control device 150 may hook the third signal 203 and then control a path such that the first data accumulatively stored in the second memory is stored in the first memory 110. A fourth signal 204 may be a signal whose path is controlled such that the first data accumulatively stored in the second memory is stored in the first memory 110.

Furthermore, the monitoring-path control device 150 may obtain communication history information on a collective communication through the computation-memory interface 140. Here, the communication history information may include history information on communications corresponding to partial computations included in computations performed before the first computation. The communication history information may be used for the processor 120 to determine the optimal chunk unit.

FIG. 3 is a block diagram for illustrating a computation-memory interface according to one or more embodiments.

Referring to FIG. 3, the computation-memory interface 140 may include a plurality of receiving terminals 141, a second memory 142, a computational device 143, and a plurality of transmitting terminals 144. The computational device 143 may be also referred to as an internal processor. FIG. 3 illustrates elements of the computation-memory interface 140 related to example embodiments. Therefore, it may be understood by those skilled in the art that other general-purpose elements may be further included, in addition to the elements illustrated in FIG. 3. Here, the plurality of receiving terminals 141 and the plurality of transmitting terminals 144 according to one or more embodiments may be implemented through a cross bar having a switching structure for high-speed data transmission. Further, the second memory 142 may be a memory physically separated from the first memory 110. The second memory according to one or more embodiments may be a scratchpad memory and include static random access memory (SRAM), but is not limited thereto.

According to one or more embodiments, an electronic device included in the computation-communication system may be connected to other electronic devices based on a topology structure. For example, the electronic device may be connected to four other electronic devices based on the topology structure. In this regard, each of IN₁, IN₂, IN₃, and IN₄ may be data received from the four other electronic devices, and each of OUT₁, OUT₂, OUT₃, and OUT₄ may be data transmitted to the four other electronic devices. However, the electronic device is not limited thereto, and irrespective of the electronic device being connected to other electronic devices, may not receive data from each of all electronic devices connected thereto and transmit the second data to each of all electronic devices connected thereto. For example, the number of the second electronic device, which is a transmitting device, among the four other electronic devices may be two, and the number of the first electronic device, which is a receiving device, among the four other electronic devices may be one, but the numbers are not limited thereto. However, irrespective of this, all of IN₁, IN₂, IN₃, IN₄, OUT₁, OUT₂, OUT₃, and OUT₄ may be illustrated in the figures related to the computation-memory interface 140. IN_{0. local} may be first data indicating a result value of a partial computation, and OUT_{0. local} may be first data accumulatively stored in a second memory and data stored in a first memory in response to a plurality of communications being completed.

The computational device 143 may perform the second computation using the first data and the data received from each of the one or more second electronic devices. To obtain the first data used to perform the second computation, the computational device 143 may read only the first data indicating a result value of a partial computation last performed from the first data accumulatively stored in the first memory 110, but is not limited thereto. For example, the computation-memory interface 140 may be configured to include a path where IN_{0. local} is directly inputted to the computational device 143 through a receiving terminal, in addition to a path where IN_{0. local} is stored in the second memory 142 through a receiving terminal. The second data computed through the second computation may be transmitted to the one or more first electronic devices through a transmitting terminal.

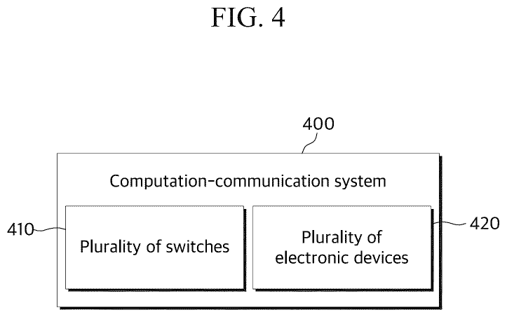

FIG. 4 is a block diagram for illustrating a computation-communication system including a plurality of switches and a plurality of electronic devices according to one or more embodiments.

Referring to FIG. 4, a computation-communication system 400 may include a plurality of switches 410 arranged in a specific topology and a plurality of electronic devices 420 connected to the plurality of switches 410. FIG. 4 illustrates elements of the computation-communication system 400 related to example embodiments. Therefore, it may be understood by those skilled in the art that other general-purpose elements may be further included, in addition to the elements illustrated in FIG. 4. The computation-memory interface 140 of the electronic device 100 may be connected to a switch corresponding to the electronic device 100.

The computation-communication system 400 may further include a system controller, separate from the processor 120 in the electronic device 100. In this case, based on a processing rate of an accelerator included in each of a plurality of electronic devices and a capacity of a second memory included in a computation-memory interface, a distributed computation may be partitioned and allocated to the plurality of electronic devices by the system controller. More specifically, data based on a first computation may be stored in the second memory and then written to a first memory. Accordingly, such that a capacity of the data based on the first computation is smaller than the capacity of the second memory, the distributed computation may be partitioned.

The topology according to one or more embodiments may correspond to one of a mesh topology, a tree topology, a ring topology, and a hybrid topology, but is not limited thereto. Further, an electronic device among the plurality of electronic devices may correspond to each node included in the topology, but is not limited thereto. For example, two or more electronic devices may correspond to some nodes included in the topology, and these nodes may be referred to as a concentrated node.

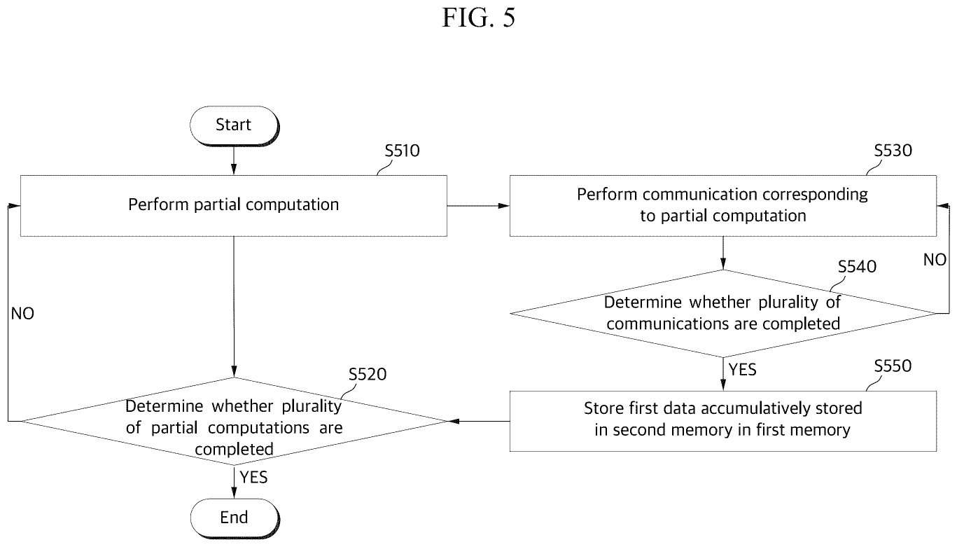

FIG. 5 is a flowchart for illustrating a parallel processing method of computation and communication, performed by an electronic device, according to one or more embodiments.

Since each operation of a parallel processing method of computation and communication, performed by the electronic device 100, in FIG. 5 may partially overlap with the above description, a description overlapping with FIGS. 1 to 4 is omitted. It may be apparent that each operation of the parallel processing method of computation and communication, performed by the electronic device 100, may be partially modified, replaced, or changed in orders of operations within the scope clearly understood by those skilled in the art.

In operation S510, the electronic device 100 may perform a partial computation. After the partial computation is completed, the electronic device 100 may determine whether to perform another partial computation subsequent to the completed partial computation. To this end, in operation S520, the electronic device 100 may determine whether a plurality of partial computations are completed. More specifically, based on whether the plurality of partial computations are performed, the electronic device 100 may perform another partial computation subsequent to the partial computation or determine that the plurality of partial computations are completed. As an example, if the plurality of partial computations are completed, a first computation may be finished. As another example, if not all the plurality of partial computations are completed and some partial computations are not performed yet, the electronic device 100 may perform another partial computation subsequent to the completed partial computation (operation S510).

If the partial computation is completed, first data indicating a result value of the partial computation may be stored in the second memory 142. In response to the first data being stored in the second memory 142, a communication corresponding to the partial computation may be triggered in the computation-memory interface 140. In this regard, the electronic device 100 may perform the communication corresponding to the partial computation (operation S530). If the communication is completed, to perform a communication corresponding to the subsequent partial computation, the electronic device 100 may determine whether a plurality of communications are completed (operation S540). As an example, if the plurality of communications are completed, a communication corresponding to the first computation may be finished. Further, the electronic device 100 may store the first data accumulatively stored in the second memory 142 in the first memory 110 (operation S550). As another example, if not all the plurality of communications are completed and communications corresponding to some partial computations are not performed yet, the electronic device 100 may perform a communication corresponding to a partial computation, which is not performed yet (operation S530). In this case, if the first data indicating a result value of another partial computation is stored in the second memory 142, the electronic device 100 may perform a communication corresponding to another partial computation. Alternatively, if the first data indicating a result value of another partial computation is not stored in the second memory 142, the electronic device 100 may operate in standby mode to perform a communication corresponding to another partial computation.

FIG. 6 is a flowchart for illustrating a method of determining a chunk unit and generating a fused kernel, performed by an electronic device, according to one or more embodiments.

In operation S610, the electronic device 100 may determine whether communication history information is present. The communication history information may include information on a time taken for a communication performed in the computation-memory interface 140. If the communication history information is not present, the electronic device 100 may read communication history information monitored through the monitoring-path control device 150 (operation S620).

In operation S630, the electronic device 100 may determine a chunk unit such that a length of a time period corresponding to a partial computation corresponds to a length of a time period corresponding to a communication. More specifically, the electronic device 100 may determine the chunk unit such that a difference between a first time expected to process a partial computation and a second time expected to process a communication corresponding to the partial computation, computed based on a variety of information, is minimized.

According to one or more embodiments, the first time based on the number of chunks may be computed based on Equation 1. Referring to Equation 1, the first time may be computed by dividing a total amount of computation of a first computation by a processing rate of the accelerator 130 and the number of chunks. However, T₁ may be adjusted based on a time actually taken for a computation prior to the first computation.

$${T}_{1} = \frac{Amount of computation}{number of chunks \times processing rate} \qquad ( 1 )$$

According to one or more embodiments, the second time may be computed based on information on data, information on a topology related to an electronic device, and information on a configured algorithm corresponding to the topology. Here, the information on the data may include information on a dimension of data such as a matrix size and information on a type of data such as half-precision floating-point (FP16) and single-precision floating-point (FP32), and the information on the configured algorithm may include formula information for computing the second time for each topology. For example, if the topology is a mesh topology, the second time based on the number of chunks may be computed based on Equation 2. However, T₂ is not limited thereto and may be adjusted based on a time actually taken for a communication based on the communication history information.

$${T}_{2} = 2 ( {N}_{r} - 1 ) ( {t}_{s} + \frac{M ( Number of chunks )}{{N}_{r} B} ) + 2 ( {N}_{c} - 1 ) ( {t}_{s} + \frac{M ( Number of chunks )}{{N}_{c} B} ) \qquad ( 2 )$$

Here, Nᵣ may be the number of rows in the mesh topology, N_{c} may be the number of columns in the mesh topology, tₛ may be a link latency, B may be a link bandwidth, and M may be a size of a message transmitted and received during a collective communication. Nᵣ and Nₑ may be included in information on the mesh topology. tₛ may be a link latency monitored by the monitoring-path control device 150 and may be calculated as a time from a time point when a second computation is completed to a time point when second data is transmitted. M may be a size of a message transmitted and received during a collective communication based on the chunk unit. Here, M may be a function of the number of chunks, and as the number of chunks is greater, M may be smaller.

The electronic device 100 may determine the number of chunks and the chunk unit such that a difference between T₁, the first time computed by Equation 1, and T₂, the second time computed by Equation 2, is the smallest. In other words, a first time period corresponding to a partial computation and a second time period corresponding to a communication may be configured to be maximally overlapped.

In operation S640, the electronic device 100 may generate a fused kernel based on the chunk unit. The fused kernel may have a structure in which a computation kernel including information on a plurality of partial computations and a communication kernel including information on a plurality of communications are integrated into a single kernel. The fused kernel may include information on a time point when each of the plurality of partial computations is initiated and information on a time point when each of the plurality of communications is initiated. If a second partial computation is performed subsequent to a first partial computation, a time point when the second partial computation is initiated and a time point when a communication corresponding to the first partial computation is initiated may be configured as being identical. In this regard, since the chunk unit is determined such that a length of a time period corresponding to a partial computation substantially corresponds to a length of a time period corresponding to a communication, a latency from a time point when a partial computation is completed to a time point when a following partial computation is initiated and a latency from a time point when a communication is completed to a time point when a following communication is initiated may be minimized.

In operation S650, the electronic device 100 may initiate the plurality of partial computations and the plurality of communications based on the fused kernel.

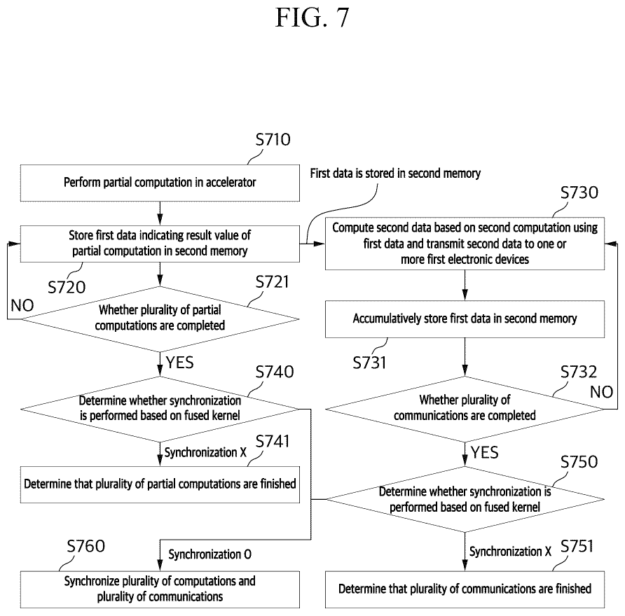

FIG. 7 is a flowchart for illustrating a parallel processing and synchronization method of computation and communication, performed by an electronic device, according to one or more embodiments.

Since operation S710, operation S720, operation S721, operation S730, operation S731, and operation S732 of a parallel processing and synchronization method of computation and communication, performed by the electronic device 100, in FIG. 7 may overlap with the above description, a description overlapping with FIGS. 1 to 6 is omitted. It may be apparent that each operation of the parallel processing method of computation and communication, performed by the electronic device 100, may be partially modified, replaced, or changed in orders of operations within the scope clearly understood by those skilled in the art.

According to one or more embodiments, whether a first computation and a communication for the first computation are synchronized may be determined based on data dependency. The data dependency may be determined based on whether data transmitted based on the communication for the first computation is used as an input of another computation subsequent to the first computation. In this regard, information indicating whether synchronization is performed, which is included in a fused kernel, may be configured based on the data dependency. In response to a plurality of partial computations being all completed, the electronic device 100 may determine whether synchronization is performed based on the fused kernel (operation S740). Further, in response to a plurality of communications being all completed, the electronic device 100 may determine whether synchronization is performed based on the fused kernel (operation S750).

As an example, if the data dependency between computation and communication is present as in a case where data transmitted based on a communication last performed is used as an input of another computation subsequent to the first computation, the first computation and the corresponding communication may be synchronized. In this regard, in response to determining that synchronization is performed based on the fused kernel, the electronic device 100 may synchronize a plurality of computations and a plurality of communications (operation S760). Accordingly, a first time point at which the plurality of partial computations are finished and a second time point at which the plurality of communications are finished may be determined to be an identical time point.

As another example, if the data dependency between computation and communication is not present as in a case where data transmitted based on a communication last performed is not used as an input of another computation subsequent to the first computation, each of the first computation and the corresponding communication may be finished asynchronously. In this regard, if it is determined that synchronization is not performed based on the fused kernel, the electronic device 100 may determine that the plurality of partial computations are finished (operation S741), and the electronic device 100 may determine that the plurality of communications are finished (operation S751). Accordingly, the first time point at which the plurality of partial computations are finished and the second time point at which the plurality of communications are finished may be determined to be different time points.

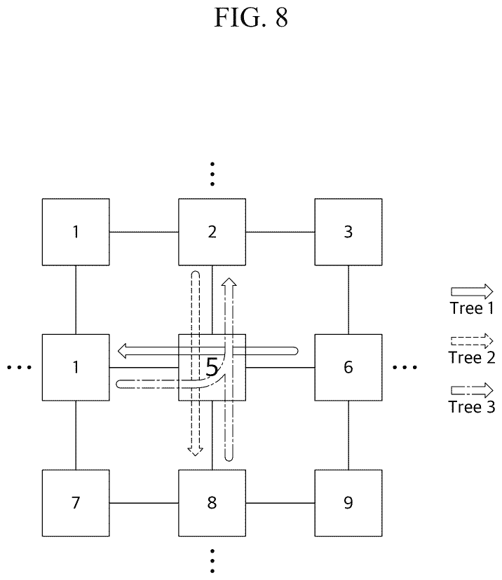

FIG. 8 is a diagram for illustrating a topology structure related to a plurality of electronic devices included in a computation-communication system according to one or more embodiments.

Referring to FIG. 8, a plurality of switches included in the computation-communication system 400 may be connected in a mesh topology structure, and each of the plurality of switches may correspond one-to-one with one of a plurality of electronic devices. An electronic device corresponding to node 5 may be connected to four electronic devices corresponding to node 1, node 2, node 6, and node 8.

The plurality of electronic devices connected in the mesh topology structure may simultaneously process a plurality of collective communications based on a first tree, a second tree, and a third tree identified based on mesh topology. In other words, it is not the case that only one collective communication is performed for one computation, and a plurality of collective communications may be simultaneously performed for one computation. For example, referring to FIG. 8, for one computation, a first collective communication corresponding to the first tree, a second collective communication corresponding to the second tree, and a third collective communication corresponding to the third tree may be performed in parallel.

To process the plurality of collective communications in parallel, the second memory 142 may include a plurality of memories (for example, SRAM), and the computational device 143 may include a plurality of computational devices. To prevent a bottleneck between the plurality of collective communications, the first tree, the second tree, and the third tree may be configured as spanning trees that do not share a direction edge from a particular node to another node with each other, but are not limited thereto.

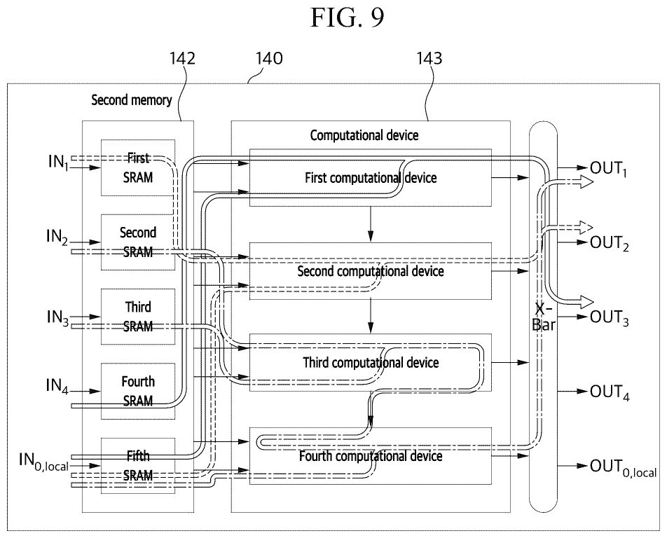

FIG. 9 is a diagram for illustrating a method of processing a plurality of collective communications, performed by an electronic device, according to one or more embodiments.

According to one or more embodiments, the computation-memory interface 140 may be a computation-memory interface included in the electronic device 100 corresponding to node 5 of FIG. 8. The second memory 142 of the computation-memory interface 140 may include a first SRAM, a second SRAM, a third SRAM, a fourth SRAM, and a fifth SRAM, and the computational device 143 may include a first computational device, a second computational device, a third computational device, and a fourth computational device.

Referring to FIG. 9, IN₁ may be data received from an electronic device corresponding to node 2, IN₂ may be data received from an electronic device corresponding to node 1, IN₃ may be data received from an electronic device corresponding to node 8, IN₄ may be data received from an electronic device corresponding to node 6, and IN_{0,local} may be first data indicating a result value of a first partial computation performed by the accelerator 130 of the electronic device 100 corresponding to node 5. Further, OUT₁ may be second data transmitted to the electronic device corresponding to node 2, OUT₂ may be second data transmitted to the electronic device corresponding to node 8, and OUT₃ may be second data transmitted to the electronic device corresponding to node 1. Referring to FIG. 8, a plurality of pieces of second data corresponding to a plurality of collective communications performed in the electronic device 100 corresponding to node 5 may be transmitted to a plurality of electronic devices corresponding to node 1, node 2, and node 8 and may not be transmitted to the electronic device corresponding to node 6. In this regard, OUT₄ is shown in FIG. 9 but may not correspond to second data. OUT_{0,local} may be first data accumulatively stored in the fifth SRAM based on a plurality of partial computations included in a first computation being sequentially completed and may be transmitted to the first memory 110 of the electronic device 100 corresponding to node 5.

According to one or more embodiments, each of a plurality of computational devices included in the computational device 143 may perform a second computation using at least some of IN₁, IN₂, IN₃, IN₄, and IN_{0,local}. As an example, the first computational device may compute the second data through the second computation using IN₄ and IN_{0,local} identified based on the first tree. The computed second data, OUT₃, may be transmitted to the electronic device corresponding to node 1. As another example, the second computational device may compute the second data through the second computation using IN₁ and IN_{0,local} identified based on the second tree. The computed second data, OUT₂, may be transmitted to the electronic device corresponding to node 8. As another example, the third computational device may perform the second computation using IN₂ and IN₃ identified based on the third tree. Subsequently, the fourth computational device may compute the second data through the second computation using data computed by the third computational device and IN_{0,local}. The computed second data, OUT₁, may be transmitted to the electronic device corresponding to node 2.

Although not illustrated in FIG. 9, the fifth SRAM may be connected to a cross bar. Accordingly, the first data accumulatively stored in the fifth SRAM after the plurality of communications are all performed may be directly transmitted to the first memory 110 of the electronic device 100 corresponding to node 5 through the cross bar.

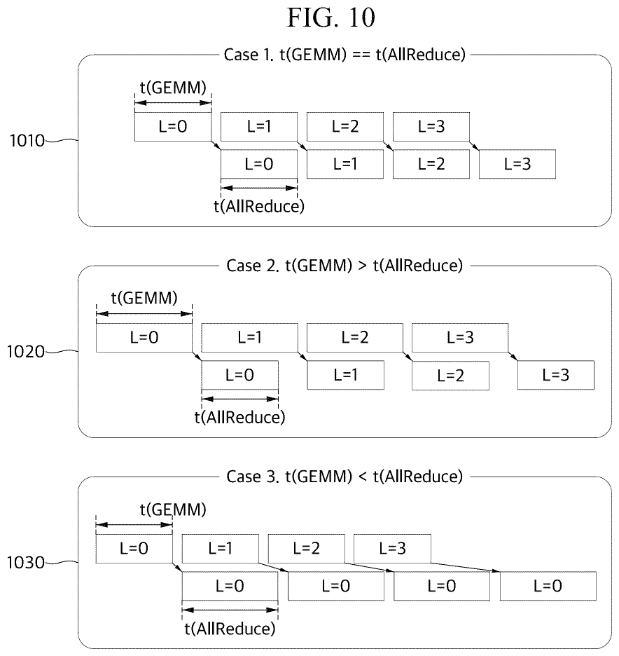

FIG. 10 is a diagram for illustrating a method of adjusting a time period of a partial computation and a time period of a communication corresponding to the partial computation by adjusting a chunk unit according to one or more embodiments.

A first time expected to process one partial computation and a second time expected to process a communication corresponding to the partial computation may vary depending on a chunk unit or the number of chunks. Accordingly, the processor 120 may determine the chunk unit such that a difference between the first time and the second time is minimized. More specifically, referring to Case 1 1010, if the chunk unit is optimized, t(GEMM), the first time, and t(AllReduce), the second time, may be calculated as being substantially identical. However, if the chunk unit is not optimized, t(GEMM), the first time, may be different from t(AllReduce), the second time. As an example, as in Case 2 1020, t(GEMM), the first time, may be calculated as being greater than t(AllReduce). As another example, as in Case 3 1030, t(GEMM), the first time, may be calculated as being smaller than t(AllReduce).

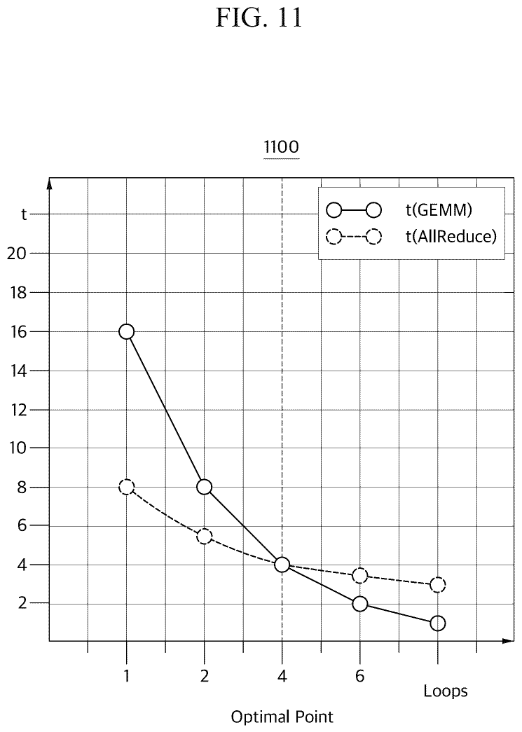

FIG. 11 is a diagram for illustrating a graph representing a time period of a partial computation and a time period of a communication corresponding to the partial computation based on a chunk unit being adjusted according to one or more embodiments.

A graph 1100 according to one or more embodiments may be a graph having the number of chunks on the x-axis and a first time and a second time on the y-axis. More specifically, FIG. 11 illustrates the first time and the second time based on the number of chunks. Referring to FIG. 11, the first time expected to process a partial computation and the second time expected to process a communication corresponding to the partial computation may be identical when the number of chunks is four. In contrast, if the number of chunks is smaller than four, the first time may be greater than the second time, and if the number of chunks is greater than four, the first time may be smaller than the second time.

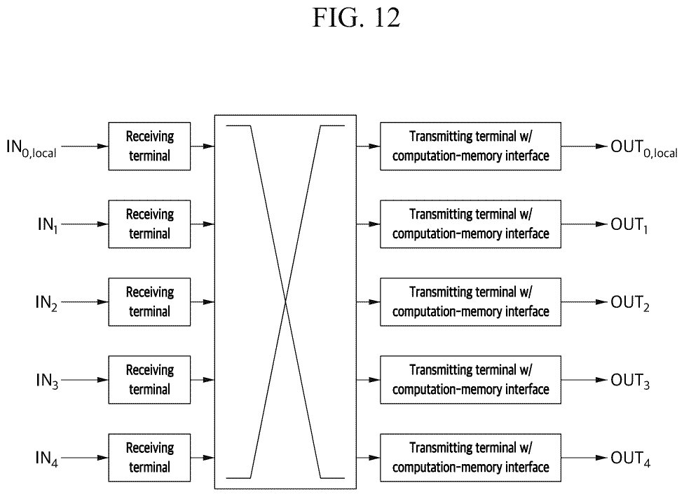

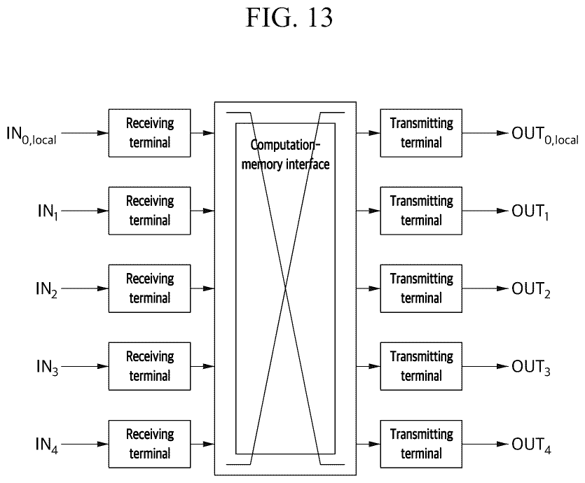

The computation-memory interface 140 according to one or more embodiments may include the plurality of receiving terminals 141, the second memory 142, the computational device 143, and the plurality of transmitting terminals 144, but is not limited thereto. For example, the computation-memory interface 140 may be a computation-memory interface including the second memory 142 and the computational device 143 in a narrow sense, and a plurality of receiving terminals and a plurality of transmitting terminals may be disposed outside the computation-memory interface 140. In this regard, the computation-memory interface 140 according to one or more embodiments is described in more detail in FIGS. 12 and 13.

FIG. 12 is a diagram for illustrating a computation-memory interface according to one or more embodiments.

Referring to FIG. 12, the computation-memory interface 140 included in the electronic device 100 may include a plurality of computation-memory interfaces, and the plurality of computation-memory interfaces may correspond one-to-one with a plurality of transmitting terminals. Each of the plurality of computation-memory interfaces may be connected to one of the plurality of transmitting terminals.

As described above, the electronic device 100 may simultaneously process a plurality of collective communications for one computation. In this case, excluding a computation-memory interface for transmitting OUT_{0,local}, each of the other computation-memory interfaces may be a dedicated interface for processing a collective communication among the plurality of collective communications. Therefore, a computation-memory interface used for a collective communication among the other computation-memory interfaces may operate in active mode, and a computation-memory interface that is not used for a collective communication may operate in inactive mode.

Each of IN₁, IN₂, IN₃, IN₄, and IN_{0,local} may be inputted to each of the other computation-memory interfaces through a cross bar. Subsequently, each of the other computation-memory interfaces may perform a second computation based on one or more pieces of input data and then transmit second data computed based on the second computation through a transmitting terminal connected thereto. For example, if the plurality of collective communications described in FIG. 8 are processed by the plurality of computation-memory interfaces of FIG. 12, a computation-memory interface connected to a transmitting terminal for transmitting OUT₁ as the second data may include a second memory 142 including the second SRAM, the third SRAM, and the fifth SRAM of FIG. 9 and a computational device 143 including the third computational device and the fourth computational device of FIG. 9. Similarly, a computation-memory interface connected to a transmitting terminal for transmitting OUT₂ as the second data may include a second memory 142 including the first SRAM and the fifth SRAM of FIG. 9 and a computational device 143 including the second computational device of FIG. 9. Further, a computation-memory interface connected to a transmitting terminal for transmitting OUT₃ as the second data may include a second memory 142 including the fourth SRAM and the fifth SRAM of FIG. 9 and a computational device 143 including the first computational device of FIG. 9.

FIG. 13 is a diagram for illustrating a computation-memory interface according to one or more embodiments.

Referring to FIG. 13, the computation-memory interface 140 included in the electronic device 100 may include a cross bar, in addition to the second memory 142 and the computational device 143. In this regard, IN₁, IN₂, IN₃, IN₄, and IN_{0,local} received to the computation-memory interface 140 and OUT₁, OUT₂, OUT₃, OUT₄, and OUT_{0,local} transmitted from the computation-memory interface 140 may be dynamically routed by the cross bar, and a data path may be selectively configured. For example, if a plurality of collective communications are simultaneously processed by the electronic device 100 corresponding to node 5 of FIG. 8, dynamic routing may be performed by the cross bar. Accordingly, the computation-memory interface 140 may perform the second computation corresponding to each of the first tree, the second tree, and the third tree and transmit the second data computed based on the second computation being performed.

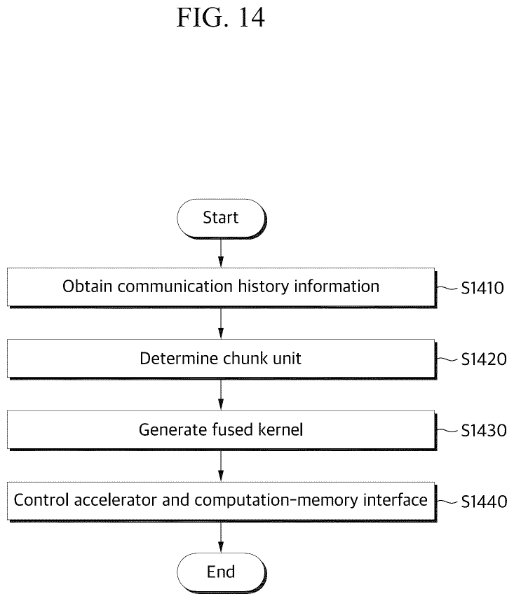

FIG. 14 is a flowchart for illustrating a parallel processing method of computation and communication, performed by an electronic device, according to one or more embodiments.

Since each operation of a parallel processing method of computation and communication, performed by the electronic device 100, in FIG. 14 may partially overlap with the above description, a description overlapping with FIGS. 1 to 13 is omitted. It may be apparent that each operation of the parallel processing method of computation and communication, performed by the electronic device 100, may be partially modified, replaced, or changed in orders of operations within the scope clearly understood by those skilled in the art.

In operation S1410, the electronic device 100 may obtain communication history information related to a communication performed in the computation-memory interface 140. The communication history information may be used to adjust a time expected to process a communication corresponding to a partial computation. Further, the communication history information may be monitored by the monitoring-path control device 150. However, without being limited thereto, information on a time actually taken for a computation performed by the accelerator 130 may also be monitored by the monitoring-path control device 150. In this case, the monitored information on the time actually taken for the computation may be used to adjust a time expected to process the partial computation.

In operation S1420, the electronic device 100 may determine a chunk unit based on the communication history information, information on a capacity of a second memory included in a computation-memory interface, information on data, information on an amount of computation of a first computation, information on a processing rate of an accelerator, information on a topology related to an electronic device, and information on a configured algorithm corresponding to the topology. As described above, the chunk unit may be determined such that a difference between a first time expected to process a partial computation and a second time expected to process a communication corresponding to the partial computation is minimized. Since user software intervention to determine the chunk unit is minimized, computation and communication processing performance may be improved.

In operation 51430, the electronic device 100 may generate a fused kernel configured such that a plurality of partial computations into which the first computation is partitioned based on the chunk unit and a plurality of communications corresponding to the plurality of partial computations are performed in an overlapping manner. Here, the fused kernel may be configured such that a time taken to process the plurality of partial computations and the plurality of communications is minimized. In this regard, if a second partial computation is performed subsequent to a first partial computation, the fused kernel may be configured such that a time period during which the second partial computation is performed subsequent to the first partial computation and a time period during which a communication corresponding to the first partial computation is performed are maximally overlapped. Further, if the computation-memory interface 140 is configured as in FIG. 13, the fused kernel may include routing information related to a cross bar.

In operation 51440, the electronic device 100 may, based on the fused kernel, control the accelerator 130 to perform the plurality of partial computations and control the computation-memory interface 140 to perform the plurality of communications. Accordingly, the accelerator 130 may perform the plurality of partial computations and the computation-memory interface 140 may perform the plurality of communications. Similarly, based on computation and communication being performed in each of a plurality of electronic devices included in the computation-communication system 400, a distributed computation may be completed.

The electronic device 100 according to the above-described example embodiments may include a processor, a memory for storing and executing program data, a permanent storage such as a disk drive, a communication port that communicates with an external device, and a user interface device such as a touch panel, a key, and a button. Methods implemented as software modules or algorithms may be stored in a computer-readable recording medium as computer-readable codes or program instructions executable on the processor. Here, the computer-readable recording medium includes a magnetic storage medium (for example, read-only memory (ROM), random-Access memory (RAM), floppy disks, and hard disks) and an optically readable medium (for example, compact disc read-only memory (CD-ROM) and digital versatile discs (DVDs)). The computer-readable recording medium may be distributed among network-connected computer systems, so that the computer-readable codes may be stored and executed in a distributed manner. The medium may be readable by a computer, stored in a memory, and executed on a processor.

In one or more embodiments, an electronic device may include: a first memory configured to store data related to a first computation; an accelerator; and a processor configured to: determine a chunk unit related to the first computation to be performed by the accelerator; partition the first computation into a plurality of partial computations based on the chunk unit; generate a fused kernel that enables an execution of the plurality of partial computations and a plurality of communications corresponding to the plurality of partial computations in an overlapping manner; and control the accelerator and a computation-memory interface based on the fused kernel; wherein the accelerator is configured to perform a first partial computation among the plurality of partial computations based on the data read from the first memory; and wherein the computation-memory interface is configured to, based on first data indicating a result value of the first partial computation being stored in a second memory, compute second data based on a second computation using the first data and perform a transmission of the second data to one or more other electronic devices.

The accelerator is further configured to, based on whether the plurality of partial computations are performed, perform a second partial computation subsequent to the first partial computation or determine that the plurality of partial computations are completed.

Based on the second partial computation being performed subsequent to the first partial computation, a first time period during which the transmission related to the first partial computation is performed, overlaps with a second time period during which the second partial computation is performed.

The processor is further configured to determine the chunk unit based on information on a capacity of the second memory, information on the data, information on an amount of computation of the first computation, information on a processing rate of the accelerator, information on a topology related to the electronic device, and information on a configured algorithm corresponding to the topology.

The processor is further configured to determine the chunk unit such that a length of the first time period corresponds to a length of the second time period.

The processor is further configured to, further based on history information on communication through the computation-memory interface, determine the chunk unit.

The electronic device may include: a monitoring-path control device configured to obtain history information on communication through the computation-memory interface.

The fused kernel is configured to integrate a computation kernel including information on the plurality of partial computations, and a communication kernel including information on the plurality of communications, into a single kernel.

The one or more other electronic devices correspond to one or more first electronic devices, wherein the computation-memory interface may include an internal processor, and wherein the internal processor may be configured to compute the second data through the second computation using the first data and data received from each of one or more second electronic devices.

Based on the plurality of partial computations being sequentially performed based on a configured computation order, the first data is accumulatively stored in the second memory included in the computation-memory interface.

Based on the plurality of partial computations being sequentially performed based on a configured computation order, the first data is accumulatively stored in a second memory of another electronic device connected to the electronic device.

The second data is transmitted to the one or more other electronic devices.

The computation-memory interface is further configured to, based on whether the plurality of communications are performed, perform a communication corresponding to another partial computation subsequent to a communication corresponding to the first partial computation or determine that the plurality of communications are completed.

Based on the plurality of communications being all performed, the first data accumulatively stored in the second memory is stored as result data from the first computation in the first memory.

A first time point at which the plurality of partial computations are finished and a second time point at which the plurality of communications are finished are determined to be an identical time point or different time points from each other based on synchronization information indicating whether synchronization is performed, the synchronization information being included in the fused kernel.

The computation-memory interface may include: a plurality of receiving terminals configured to receive the data from each of the one or more second electronic devices and the first data from the accelerator; and a plurality of transmitting terminals configured to transmit the second data to the one or more first electronic devices or transmit the first data accumulatively stored in the second memory to the first memory.

The computation-memory interface may include a plurality of computation-memory interfaces. Each of the plurality of computation-memory interfaces is connected to one of a plurality of transmitting terminals configured to transmit the second data to the one or more first electronic devices or transmit the first data accumulatively stored in the second memory to the first memory.

The electronic device may include: a monitoring-path control device configured to: control a first write signal to store the first data indicating the result value of the first partial computation, in the second memory; and based on the plurality of communications being all performed, control a second write signal to write the first data accumulatively stored in the second memory, to the first memory.

In one or more embodiments, a parallel processing method performed by an electronic device including a first memory in which data related to a first computation is stored, a processor, an accelerator, a computation-memory interface, and a monitoring-path control device, may include: obtaining communication history information related to a communication performed in the computation-memory interface; determining a chunk unit based on the communication history information, information on a capacity of a second memory included in the computation-memory interface, information on the data, information on an amount of computation of the first computation, information on a processing rate of the accelerator, information on a topology related to the electronic device, and information on a configured algorithm corresponding to the topology; partition the first computation into a plurality of partial computations based on the chunk unit; generating a fused kernel that enables an execution of the plurality of partial computations and a plurality of communications corresponding to the plurality of partial computations in an overlapping manner; and based on the fused kernel, controlling the accelerator to perform the plurality of partial computations and controlling the computation-memory interface to perform the plurality of communications.

In one or more embodiments, a computation-communication system may include: a plurality of switches having a topology; and a plurality of electronic devices connected to the plurality of switches, wherein, based on a receiving device for an electronic device among the plurality of electronic devices, including one or more first electronic devices, and a transmitting device for the electronic device, including one or more second electronic devices, wherein the electronic device may include: a first memory configured to store data related to a first computation; and a processor configured to: determine a chunk unit related to the first computation be performed by an accelerator; partition the first computation into a plurality of partial computations based on the chunk unit; generate a fused kernel configured that enables an execution of a plurality of partial computations and a plurality of communications corresponding to the plurality of partial computations in an overlapping manner; and control the accelerator and a computation-memory interface based on the fused kernel, wherein the accelerator is configured to perform a first partial computation among the plurality of partial computations based on the data read from the first memory; and wherein the computation-memory interface is configured to, based on first data indicating a result value of the first partial computation being stored in a second memory, compute second data based on a second computation using the first data and data received from each of the one or more second electronic devices, and perform a transmission of the second data to the one or more first electronic devices.

The example embodiments may be represented by functional block elements and various processing steps. The functional blocks may be implemented in any number of hardware and/or software configurations that perform specific functions. For example, one or more embodiments may adopt integrated circuit configurations, such as memory, processing, logic, and/or look-up table, which may execute various functions by the control of one or more microprocessors or other control devices. Similar to elements being implemented as software programming or software elements, the example embodiments may be implemented in a programming or scripting language such as C, C++, Java, and assembler, including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means,” and “configuration” may be used broadly and are not limited to mechanical and physical configurations. The terms may include the meaning of a series of routines of software in association with a processor or the like.

The above-described example embodiments are examples, and other example embodiments may be implemented within the scope of the appended claims.

What is claimed is:

1. An electronic device comprising:
a first memory configured to store data related to a first computation;
an accelerator; and
a processor configured to:
determine a chunk unit related to the first computation to be performed by the accelerator;
generate a fused kernel that enables an execution of a plurality of partial computations into which the first computation is partitioned based on the chunk unit and a plurality of communications corresponding to the plurality of partial computations in an overlapping manner; and
control the accelerator and a computation-memory interface based on the fused kernel;
wherein the accelerator is configured to perform a first partial computation among the plurality of partial computations based on the data read from the first memory; and
wherein the computation-memory interface is configured to, based on first data indicating a result value of the first partial computation being stored in a second memory, compute second data based on a second computation using the first data and perform a transmission of the second data to one or more first electronic devices.

2. The electronic device of claim 1,
wherein the accelerator is further configured to, based on whether the plurality of partial computations are performed, perform a second partial computation subsequent to the first partial computation or determine that the plurality of partial computations are completed.

3. The electronic device of claim 2,
wherein, based on the second partial computation being performed subsequent to the first partial computation, a first time period during which the transmission related to the first partial computation is performed, overlaps with a second time period during which the second partial computation is performed.

4. The electronic device of claim 1,
wherein the processor is further configured to determine the chunk unit based on information on a capacity of the second memory, information on the data, information on an amount of computation of the first computation, information on a processing rate of the accelerator, information on a topology related to the electronic device, and information on a configured algorithm corresponding to the topology.

5. The electronic device of claim 3,
wherein the processor is further configured to determine the chunk unit such that a length of the first time period corresponds to a length of the second time period.

6. The electronic device of claim 4,
wherein the processor is further configured to, further based on history information on communication through the computation-memory interface, determine the chunk unit.

7. The electronic device of claim 1, further comprising:
a monitoring-path control device configured to obtain history information on communication through the computation-memory interface.

8. The electronic device of claim 1,
wherein the fused kernel is configured to integrate a computation kernel including information on the plurality of partial computations, and a communication kernel including information on the plurality of communications, into a single kernel.

9. The electronic device of claim 1,
wherein the computation-memory interface comprises an internal processor, and
wherein the internal processor is configured to compute the second data through the second computation using the first data and data received from each of one or more second electronic devices.

10. The electronic device of claim 9,
wherein, based on the plurality of partial computations being sequentially performed based on a configured computation order, the first data is accumulatively stored in the second memory included in the computation-memory interface.

11. The electronic device of claim 9,
wherein, based on the plurality of partial computations being sequentially performed based on a configured computation order, the first data is accumulatively stored in a second memory of another electronic device connected to the electronic device.

12. The electronic device of claim 9,
wherein the second data is transmitted to the one or more first electronic devices.

13. The electronic device of claim 1,
wherein the computation-memory interface is further configured to, based on whether the plurality of communications are performed, perform a communication corresponding to another partial computation subsequent to a communication corresponding to the first partial computation or determine that the plurality of communications are completed.

14. The electronic device of claim 10,
wherein, based on the plurality of communications being all performed, the first data accumulatively stored in the second memory is stored as result data from the first computation in the first memory.

15. The electronic device of claim 1,
wherein a first time point at which the plurality of partial computations are finished and a second time point at which the plurality of communications are finished are determined to be an identical time point or different time points from each other based on synchronization information indicating whether synchronization is performed, the synchronization information being included in the fused kernel.

16. The electronic device of claim 10,
wherein the computation-memory interface comprises:
a plurality of receiving terminals configured to receive the data from each of the one or more second electronic devices and the first data from the accelerator; and
a plurality of transmitting terminals configured to transmit the second data to the one or more first electronic devices or transmit the first data accumulatively stored in the second memory to the first memory.

17. The electronic device of claim 10,
wherein the computation-memory interface comprises a plurality of computation-memory interfaces, and
wherein each of the plurality of computation-memory interfaces is connected to one of a plurality of transmitting terminals configured to transmit the second data to the one or more first electronic devices or transmit the first data accumulatively stored in the second memory to the first memory.

18. The electronic device of claim 14, further comprising:
a monitoring-path control device configured to:
control a first write signal to store the first data indicating the result value of the first partial computation, in the second memory; and
based on the plurality of communications being all performed, control a second write signal to write the first data accumulatively stored in the second memory, to the first memory.

19. A parallel processing method performed by an electronic device comprising a first memory in which data related to a first computation is stored, a processor, an accelerator,
a computation-memory interface, and a monitoring-path control device, the parallel processing method comprising:
obtaining communication history information related to a communication performed in the computation-memory interface;
determining a chunk unit based on the communication history information, information on a capacity of a second memory included in the computation-memory interface, information on the data, information on an amount of computation of the first computation, information on a processing rate of the accelerator, information on a topology related to the electronic device, and information on a configured algorithm corresponding to the topology;
generating a fused kernel that enables an execution of a plurality of partial computations into which the first computation is partitioned based on the chunk unit and a plurality of communications corresponding to the plurality of partial computations in an overlapping manner; and
based on the fused kernel, controlling the accelerator to perform the plurality of partial computations and controlling the computation-memory interface to perform the plurality of communications.

20. A computation-communication system comprising:
a plurality of switches having a topology; and
a plurality of electronic devices connected to the plurality of switches,
wherein, based on a receiving device for an electronic device among the plurality of electronic devices, comprising one or more first electronic devices, and a transmitting device for the electronic device, comprising one or more second electronic devices, the electronic device comprises:
a first memory configured to store data related to a first computation;
a processor configured to:
determine a chunk unit related to the first computation be performed by an accelerator;
generate a fused kernel that enables an execution of a plurality of partial computations into which the first computation is partitioned based on the chunk unit and a plurality of communications corresponding to the plurality of partial computations in an overlapping manner; and
control the accelerator and a computation-memory interface based on the fused kernel;
wherein the accelerator is configured to perform a first partial computation among the plurality of partial computations based on the data read from the first memory; and
wherein the computation-memory interface is configured to, based on first data indicating a result value of the first partial computation being stored in a second memory, compute second data based on a second computation using the first data and data received from each of the one or more second electronic devices, and perform a transmission of the second data to the one or more first electronic devices.
